(19) United States
(12) Patent Application Publication
(10) Pub. No.: US 2003/0095071 A1
(43) Pub. Date: May 22, 2003

(54) Structure forming a PIFA antenna and a shield container in a portable electronic apparatus

(75) Inventors: Anja Skrivervik, Champvent (CH); Jean-Francois Zurcher, Tavel/Clarens (CH)

Correspondence Address: SUGHRUE MION, PLLC, 2100 PENNSYLVANIA AVENUE, N.W., WASHINGTON, DC, 20037, US

(73) Assignee: ASULAB S.A.

(21) Appl. No.: 10/259,568

(22) Filed: Sep. 30, 2002

(30) Foreign Application Priority Data
Nov. 21, 2001 (CH) 2140/01

(51) Int. Cl. H01Q 1/24; H01Q 1/52

(52) U.S. Cl. 343/702; 343/841; 343/718

(57) ABSTRACT

The structure described forms a PIFA antenna (10) and a shield container (11) which can contain electric circuits, particularly a transceiver associated with the antenna. It is arranged to be incorporated in a portable electronic apparatus of small volume, for example a wristwatch. In order to be as far away as possible from a body located under the apparatus and capable of absorbing or disturbing part of the radiation, the antenna (10) is arranged in the top part of the structure. The cover (14) of the case (11) includes a substantially plane external surface and an indentation (17) in a peripheral zone of the cover. The radiating element (20) of the antenna extends in the plane of said external surface, above said indentation whose bottom surface (18) forms the antenna's ground plane.

The present invention concerns a structure forming an antenna and a shield container able to contain electronic circuits in a portable apparatus, particularly a watch, the container including a cover and a side wall, the antenna including an elongated radiating element arranged opposite a ground plane that forms part of the container, the radiating element having one end connected to the ground plane by a short-circuit connection and an opposite free end.

The invention also concerns a portable electronic apparatus including such an antenna structure, particularly a wristwatch. This invention applies, in particular, to apparatuses capable of transmitting and/or receiving high frequency electromagnetic signals and for example assuring radio communication with other apparatuses on a mobile telephone network or in a data transfer network.

A PIFA antenna structure of this type and the incorporation thereof in a portable apparatus of small volume such as a timepiece are described in European Patent Application No. EP 1 093 098 by the same Applicant, which corresponds to U.S. Pat. No. 6,373,439 and is incorporated herein by reference. In particular, the reader will find in the aforecited document, a description of the prior art and the principles of the structure of a PIFA (Planar Inverted-F Antenna) antenna. Other PIFA antenna structures intended for apparatus of small size are described for example in Patent publications U.S. Pat. Nos. 6,025,805, 6,130,650, WO 97/44856, WO 01/08257 and EP 1 096 602.

In order to incorporate such an antenna in a portable unit of small volume, such as a watch, solutions need to be found which advantageously combine compactness with efficiency allowing radio communication in the most favourable conditions.

The structure disclosed in European Patent No. 1 093 098 preferably has a generally cylindrical shape of low height, to be able to be housed in a wristwatch case. The radiating element of the PIFA antenna is arranged laterally, at a constant distance from the side wall of the case. It can either form a projecting portion with respect to the generally cylindrical contour of the shield container, or follow the contour while the container has an indentation laterally of constant depth in the zone covered by the radiating element.

The antenna proposed in this document has the advantage of being able to be completely integrated in a structure of small volume that combines compactness, rigidity and aesthetics, the radiating element forming an integral part of a container forming the ground plane of the antenna. The sizing and the tuning and matching of the antenna's characteristics (frequency, pass band, impedance, etc.) are relatively easy.

The container forming the ground plane of the antenna advantageously allows all or part of the electronic circuits of the portable communication unit to be housed inside the antenna structure, the container thus forming a shield container inside which the electronic circuits are protected and in no way affect the efficiency of the antenna. The antenna proposed can thus advantageously be powered from the inside of the container thereby formed.

The structure proposed elegantly combines the ground plane of the antenna and a container for housing not only the electronic circuits of the portable unit, but also the other components that may be present in the unit. This structure can thus advantageously form a container for housing the movement of a timepiece as well. The structure can also be surrounded by or embedded in an external plastic element. This external element can thus take various forms, for example the middle part of a watchcase.

The radiating element of the antenna is small electrically, but the influence of the complete structure (including the container) determines the antenna's radiation properties. Associated with small losses due to the absence of a dielectric between the radiating element and the ground plane, or more exactly to the presence of a dielectric formed solely of air, this leads to remarkable antenna gain and efficiency.

However, since the antenna structure according to the aforementioned document EP 1 093 098 has a generally flattened shaped and thus usually extends into the general plane of the portable apparatus, the operation of the antenna is slightly adversely affected when the antenna is placed against a body whose presence may disturb the surrounding electric field, for example a metal body or a human body. This is precisely the case with the lateral arrangement of the antenna in a wristwatch, the antenna being located so close to the arm of the person wearing it that the arm absorbs part of the antenna radiation.

The object of the present invention is to improve such an antenna structure so as to overcome the aforementioned drawback, while maintaining the essential advantages of the structure disclosed in the aforecited document.

There is thus provided a structure of the type indicated in the preamble, characterised in that the cover of the container includes a substantially plane outer surface and an indentation arranged in a peripheral zone of the cover and set back with respect to the plane of said outer surface, and in that the radiating element extends substantially in said plane above said indentation a bottom surface of which forms the ground plane opposite the radiating element.

Thus all the advantages of the structure container according to the prior art are preserved, even increasing the surface available inside the container as much as possible, whereas the antenna part is located entirely in the upper part of the structure, thus as far as possible from a body on which the lower face of the apparatus is placed. In the case of a wristwatch, the distance between the antenna and the arm is thus much greater than in the case of the aforecited document. Moreover, since the surface area of the container cover is usually much greater than that of the side wall, the radiating element can be wider and thus more efficient.

Other features and advantages will appear in the following description of a preferred embodiment, given by way of non-limiting example with reference to the annexed drawings, in which:

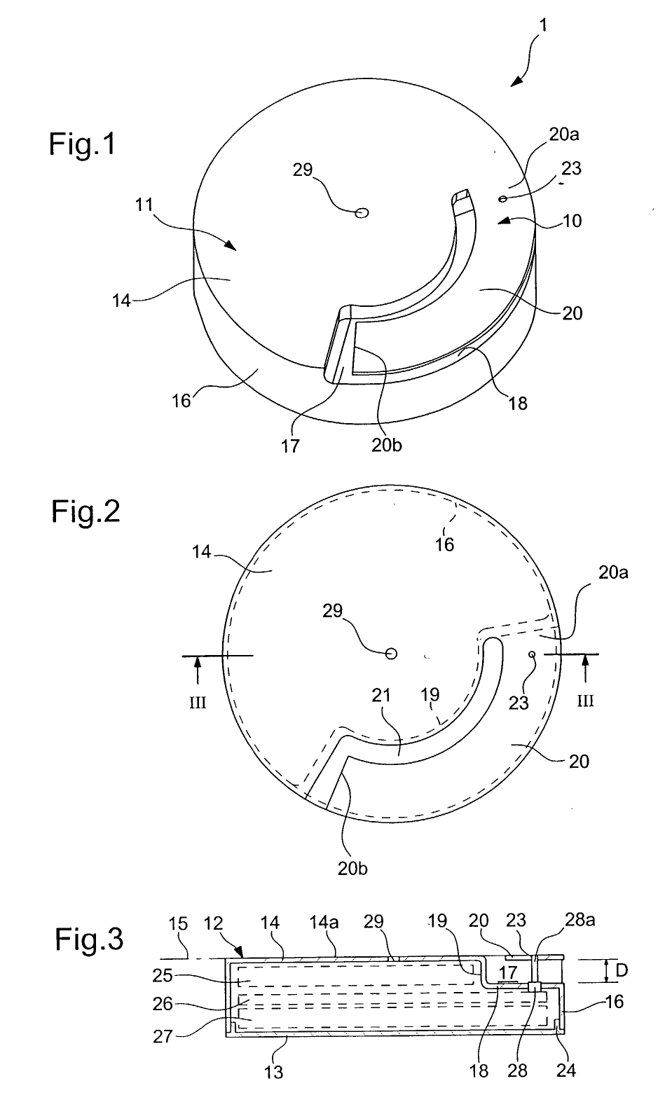

FIG. 1 is a schematic perspective view of a PIFA antenna structure according to the invention, capable of being incorporated in a portable electronic apparatus such as a watch;

FIG. 2 is a plan view of the object of FIG. 1;

FIG. 3 is a cross-section along the line III-III of FIG. 2, and

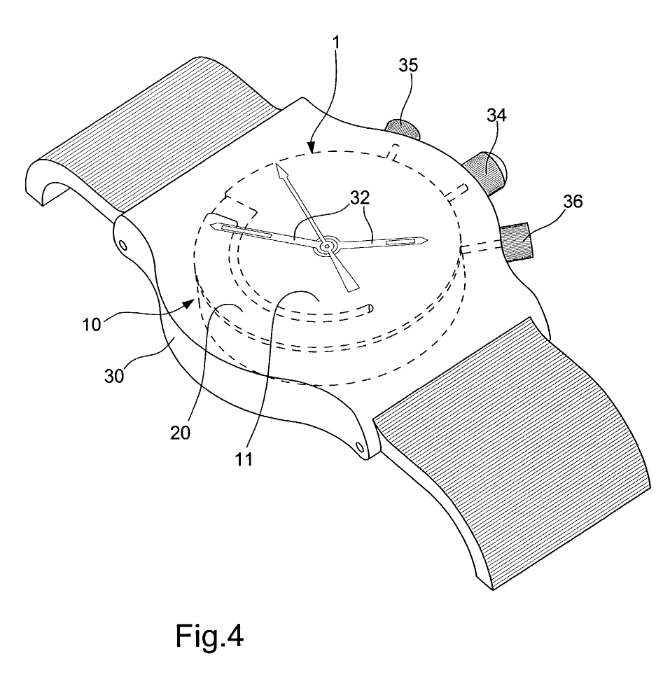

FIG. 4 is a schematic perspective view of a wristwatch including the PIFA antenna structure illustrated by FIGS. 1 to 3.

The structure described hereinafter with reference to FIGS. 1 to 3 constitutes a preferred embodiment of an antenna structure which can advantageously be incorporated in a timepiece provided with a radio transmitter-receiver, for example in the 2.45 GHz band.

The structure shown forms, on the one hand, an antenna, indicated as a whole by the reference 10 in FIG. 1 and, on the other hand, an electromagnetic shield container, indicated by the reference 11 and formed for example of two parts, as can be seen in FIG. 3, namely a top part 12 and a bottom 13. Top part 12 includes a cover 14, whose external surface 14a extends substantially in a plane 15, and a side wall 16 generally perpendicular to this plane. In the present case, structure 1 has a generally cylindrical shape of a low height with respect to its diameter, its side wall 16 is cylindrical and its bottom 13 is flat.

In a peripheral zone of structure 1, cover 14 has an indentation 17 of generally bowed shape, the depth and width of which are substantially constant. This indentation is limited downwards by a horizontal plane surface 18 of the container, which is parallel to plane 15, and laterally by a vertical surface 19 connected to lateral wall 16 of the container. Above indentation 17, cover 14 is extended by a horizontal strip extending along plane 15 and forming radiating element 20 of antenna 10. This element is located at a distance D from bottom surface 18, which forms the ground plane of the antenna. Distance D is constant across the whole of the radiating element in the present example, but this is not necessary in all cases. Element 20 has an elongated shape in the shape of an arc of a circle, and its width is preferably constant and less than that of indentation 17, such that it is separated from wall 19 by a slot 21 of constant width. One end 20a of element 20 is mechanically and electrically connected to cover 14, such that it is connected to ground plane 18 by a short-circuit connection. Its other end 20b is free. At a determined distance from its short-circuited end 20a, the radiating element carries a connection point 23, the use of which will be indicated hereinafter.

It will be noted that structure 1 described hereinbefore has an external cylindrical contour without any protruding parts, which facilitates its integration in a generally circular watchcase. However, this configuration could be different depending on requirements, particularly for incorporation into a rectangular apparatus. In the example shown, the two parts 12 and 13 are entirely metallic, for example made of brass. Bottom 13 includes in this case an inner edge 24 which can be threaded externally to be screwed into a corresponding screw thread of lateral wall 16, thus assuring a good electric connection between the two part of the shield container. A different type of assembly may, however, be provided, for example a bayonet, driving in or welding type assembly.

Preferably, cover 14 and radiating element 20 are made in a single piece, formed by a plane plate. In a metal embodiment, this plate can be welded to walls 16, 18 and 19 to form top part 12 of the container. This allows easy manufacturing and good dimensional precision for the antenna.

In another embodiment, the two parts 12 and 13 could be formed by parts made of moulded dielectric material and provided with a metallic coating able to fulfil the electric functions of the antenna and shield.

As is known, the length of radiating element 20 is chosen as a function of the radiation wavelength λ to be transmitted or received and preferably corresponds to approximately λ/4, which has a value of around 32 mm for the frequency of 2.45 GHz. Thus, if structure 1 has an external diameter of the order of 35 mm to be able to be incorporated in a watch, indentation 19 and radiating element 20 extend over considerably less than half of the periphery of the structure and thus only occupy a small fraction of the surface area of the container.

FIG. 3 shows schematically three different components able to be housed inside shield container 11, in particular an electronic watch movement 25, a unit 26 including a transceiver associated with antenna 10, and an electric power source 27 including, for example, an accumulator able to be recharged by induction. Container 11 prevents any electromagnetic interference between these components and antenna 10. Unit 26 is connected to the antenna by a coaxial line 28 whose internal conductor 28a, insulated from the ground plane, passes through surface 18 of the container through an orifice 29 to be connected to connection point 23 of radiating element 20. External conductor 28b of the coaxial line is connected to the ground plane formed by surface 18. A hole 29 at the centre of cover 14 allows external display members to be connected to watch movement 25 and, if necessary, to other members housed inside container 11.

Although the embodiment described hereinbefore has a generally cylindrical configuration which is typically suited to horological use, it will be understood that the antenna structure according to the present invention can take various forms depending upon the space requirement restrictions of the portable unit in which the structure is incorporated. The antenna structure can thus perfectly well have a substantially rectangular, elliptical or polygonal contour.

FIG. 4 shows a schematic perspective view of a timepiece taking the form of an analogue display wristwatch which contains structure 1 illustrated in FIGS. 1 to 3. Structure 1 forming an antenna 10 is thus surrounded and incorporated in an external element made of a non conductive material, particularly a plastic material, in this case a watch case middle part 30. The timepiece movement is advantageously placed entirely inside structure 1. The top plane surface of container 11 and radiating element 20 can act as the watch dial or can be covered by a disc of dielectric material forming a conventional dial, as desired.

Antenna 10 is thus located in a region of the wristwatch which is as far away as possible from the arm of the person wearing it, which minimises the influence of the arm on the antenna's performance, as was explained hereinbefore.

Orifices of small diameter can be arranged in container 11 of structure 1, without substantially affecting the characteristics of antenna 10, to allow the passage, if necessary, of constituent elements of display and/or control members, these members being electrically insulated from structure 1. In the example of FIG. 4, staffs or bushes for the hour and minute hands 32 thus pass through hole 29 provided at the centre of container 11. Likewise, stems of various control members penetrate laterally through the cylindrical lateral wall of container 11, these control members including in particular a rotating stem secured to a time-setting crown 34 and two push-buttons 35 and 36.

Structure 1 is arranged in watch middle part 30 preferably so that radiating element 20 of antenna 10 is located opposite control members 34, 35 and 36, and generally distant from any member penetrating the interior of the container of structure 1.

An antenna structure according to the present invention can thus be made to be incorporated in a timepiece, such as a watch, and to receive inside the shield container all or part of a radio-frequency transceiver, the electronic circuits of the timepiece and its movement. However, the applications of the invention extend more generally to any portable electronic apparatus having a radio-frequency transmission and/or reception function.

It will be understood that various modifications or adaptations can be made to the structure described here without departing from the scope defined by the annexed claims. In particular, depending upon the desired antenna characteristics, the radiating element can have a more complex configuration, for example in accordance with the teaching of European Patent Application No EP 1 096 602, and can be short-circuited to the ground plane across only part of its end connected to the container.

What is claimed is:

1. A structure forming an antenna and a shield container able to contain electronic circuits for a portable apparatus, said shield container including a cover and a lateral wall, said antenna including an elongated radiating element arranged opposite a ground plane which forms part of the container, said radiating element having one end connected to the ground plane by a short-circuit connection and an opposite free end,
wherein the cover of said shield container includes a substantially plane external surface and an indentation arranged in a peripheral zone of the cover and set back with respect to the plane of said external surface, and wherein said radiating element extends substantially in said plane above said indentation, a bottom surface of which forms the ground plane opposite the radiating element.

2. A structure according to claim 1, wherein said shield container has a curved lateral contour at least in the region of the antenna and wherein said radiating element has, in said plane, a curved shape which follows said contour of the container.

3. A structure according to claim 1, having a generally cylindrical external shape and wherein said indentation and said radiating element have an arcuate shape.

4. A structure according to claim 1, wherein said shield container has a closed configuration and includes a bottom on its face opposite the cover.

5. A structure according to claim 4, wherein said bottom is formed by a part separate from the rest of the container.

6. A structure according to claim 1, made of metal.

7. A structure according to claim 1, made of a dielectric material covered with an electrically conductive layer.

8. A portable electronic apparatus including a structure forming an antenna and a shield container able to contain electronic circuits, said shield container including a cover and a lateral wall, said antenna including an elongated radiating element arranged opposite a ground plane which forms part of the container, said radiating element having one end connected to the ground plane by a short-circuit connection and an opposite free end,
wherein the cover of said shield container includes a substantially plane external surface and an indentation arranged in a peripheral zone of the cover and set back with respect to the plane of said external surface, and wherein said radiating element extends substantially in said plane above said indentation, a bottom surface of which forms the ground plane opposite the radiating element.

9. An apparatus according to claim 8, wherein an electronic unit including a transceiver is housed inside said shield container.

10. An apparatus according to claim 8, formed by a wristwatch and including a timepiece movement inside said shield container.
